(19) United States
(12) Patent Application Publication
(10) Pub. No.: US 2007/0220144 A1
(43) Pub. Date: Sep. 20, 2007

(54) System and method for activity monitoring and alerting

(76) Inventor: Robert C. Lovell, Leesburg, VA (US)

Correspondence Address: PAUL, HASTINGS, JANOFSKY & WALKER LLP, P.O. BOX 919092, SAN DIEGO, CA, 92191-9092, US

(21) Appl. No.: 11/717,690

(22) Filed: Mar. 14, 2007

Related U.S. Application Data
(60) Provisional application No. 60/783,032, filed on Mar. 17, 2006.

(51) Int. Cl. G06F 15/173

(52) U.S. Cl. 709/224

(57) ABSTRACT

An Internet activity monitoring and alerting capability operating within a Service Provider (SP) provides value-added services to Service Users (SUs, e.g., users of Wireless Devices). Through the optional use of a Messaging Inter-Carrier Vendor a SP may reach a broad universe of SUs. As a SP monitors activity it looks for the occurrence of a SU-defined event. When a SU-defined event is identified a SU is alerted to the event occurrence through, for example, one or more Short Message Service or Multimedia Message Service messages. A SU may optionally elect to have certain events blocked automatically. Additionally, a SU may optionally elect to manually block certain events (on an event-by-event basis).

This application claims the benefit of U.S. Provisional Patent Application No. 60/783,032, filed on Mar. 17, 2006, which is herein incorporated by reference in its entirety.

### BACKGROUND

1. Field of the Invention

The present invention relates generally to telecommunications services. More particularly, the present invention relates to capabilities that enhance substantially the value and usefulness of various wireless messaging paradigms including, inter alia, Short Message Service (SMS) and Multimedia Message Service (MMS).

2. Background of the Invention

As the ‘wireless revolution’ continues to march forward the ability of a Service User (SU), for example a user of a Wireless Device (WD) such as a cellular telephone or a BlackBerry that is serviced by a Wireless Carrier (WC), to use their WD to comprehensively manage, within a truly ubiquitous cross-carrier environment, key aspects of their life grows in importance while, simultaneously, the challenges that are associated with same similarly increase.

The present invention offers capabilities such as these and addresses various of the not insubstantial challenges that are associated with same.

For purposes of illustration consider the following hypothetical example. Mary, our SU, wishes to monitor the usage of, and the activity that takes place on, the several PCs that she has throughout her house. Among other things Mary may wish to ensure that her son does not visit any of the many adult entertainment Web sites that are available through the World Wide Web (WWW) or participate in discussions in selected on-line forums (such as, for example, chat rooms). Additionally, Mary may wish to ensure that her daughter does not illegally download songs, movies, etc. through any of the many file sharing facilities (such as, for example, LimeWire) that are available through the Internet. Further, Mary may wish to monitor her children's visits to, and posting of material on, any of the many social networking sites (such as, for example, MySpace.com) that are available through the WWW/Internet.

The specific examples that were presented above are illustrative only and it will be readily apparent to one of ordinary skill in the relevant art that numerous other examples (of usage) are easily possible.

The present invention enables Mary, as a SU, to comprehensively monitor, be alerted to identified events, and optionally dynamically control various activities using her WM.

The present invention may leverage the capabilities of a centrally-located, full-featured Messaging Inter-Carrier Vendor (MICV) facility. While the discussion below will include a MICV it will be readily apparent to one of ordinary skill in the relevant art that other arrangements are equally applicable and indeed are fully within the scope of the present invention.

In the discussion below the present invention is described and illustrated as being offered by a Service Provider (SP). A SP may, for example, be realized as a third-party service bureau, an element of a WC or a landline carrier, an element of a MICV, an element of a cable company or other similarly-situated utility, an element of an Internet Service Provider (ISP), etc.

### SUMMARY OF THE INVENTION

Embodiments of the present invention provide mechanisms through which Internet activity may be monitored and a SU's WD may be utilized to receive notification of, and optionally automatically or conditionally block, such activity when that activity meets or matches various SU-defined criteria.

In an embodiment of the invention a SP (1) receives an indication of the occurrence of an event, said event previously defined by a SU, (2) performs one or more processing steps on said received indication, (3) identifies zero, one, or more alert conditions, (4) conditionally generates zero, one, or more notification messages, and (5) dispatches said notification messages to a WD of said SU.

Another embodiment of the invention includes (1) a MICV that is in communication with SU's WDs via their respective WCs and (2) a SP, wherein the system is able to receive at the SP indications of the occurrence of an event, said event previously defined by a SU; perform an appropriate set of processing activities in accordance with said event; identify zero, one, or more alert conditions; conditionally generate zero, one, or more notification messages; and dispatch said notification messages to a WD of a SU.

These and other features of the embodiments of the present invention along with their attendant advantages will be more fully appreciated upon a reading of the following detailed description in conjunction with the associated drawings.

### BRIEF DESCRIPTION OF THE DRAWINGS

FIG. 1 illustrates various of the exchanges or interactions that are possible during the Registration aspects of the present invention.

FIG. 2 illustrates various of the exchanges or interactions that are possible during the Monitoring and Alerting aspects of the present invention.

FIG. 3 is a diagrammatic presentation of aspects of an exemplary SP Application Server (AS).

### DETAILED DESCRIPTION OF THE INVENTION

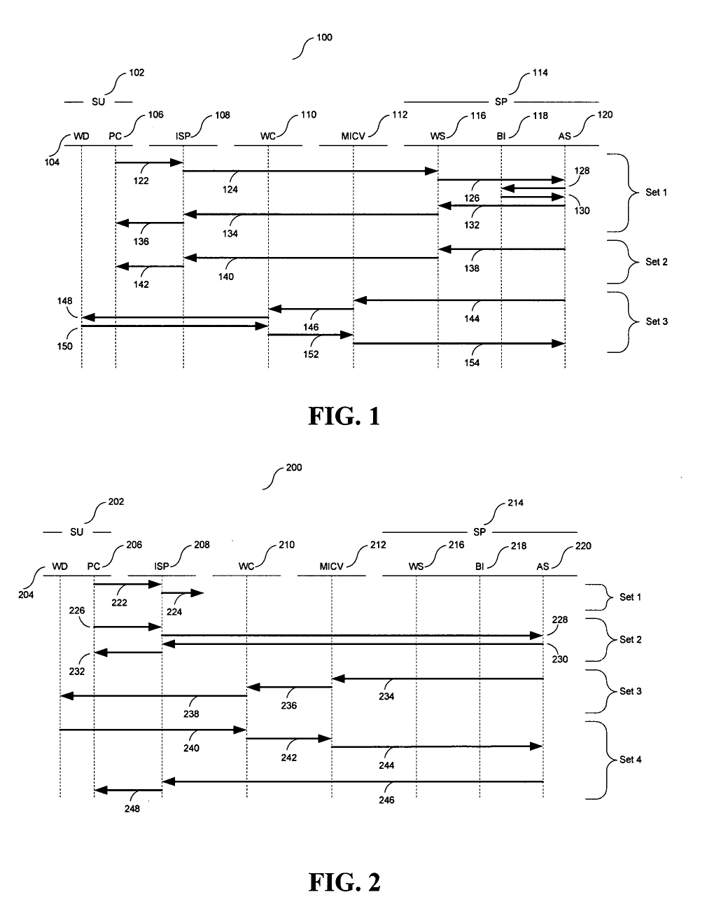

To better understand the particulars of the present invention consider for a moment FIG. 1. This figure illustrates various of the exchanges or interactions that are possible during the Registration aspects of the present invention. Of interest and note in the diagram are the following entities:

SU 102 WD 104. For example, a SU's wireless device such as a cellular telephone, BlackBerry, PalmPilot, etc.

SU 102 Personal Computer (PC) 106. For example, a SU's home, etc. PC.

ISP 108. The provider of the SU's Internet access service—e.g., dial-up, cable model, Digital Subscriber Line (DSL), etc.

WC 110. The provider of service for the SU's WD.

MICV 112. As noted above the present invention may leverage the capabilities of a centrally-located, full-featured MICV facility. Reference is made to U.S. Pat. No. 7,154,901 entitled “INTERMEDIARY NETWORK SYSTEM AND METHOD FOR FACILITATING MESSAGE EXCHANGE BETWEEN WIRELESS NETWORKS,” and its associated continuations, for a description of a MICV, a summary of various of the services/functions/etc. that are performed by a MICV, and a discussion of the numerous advantages that arise from same. In brief, a MICV may be disposed between, possibly inter alia, multiple WCs (WC₁→WCₓ) on one side and multiple SPs (SP₁→SP_{y}) on the other side thus ‘bridging’ all of the connected entities. A MICV thus, as one simple example, may offer various routing, formatting, delivery, value-add, etc. capabilities that provide, possibly inter alia:

1) A WC (and, by extension, all of the mobile subscribers that are serviced by the WC) with ubiquitous access to a broad universe of SPs, and

2) A SP with ubiquitous access to a broad universe of WCs (and, by extension, to all of the mobile subscribers that are serviced by the WCs).

SP 114 Web Server (WS) 116. A publicly-available Web site that is provided by a SP.

SP 114 Billing Interface (BI) 118. A single, consolidated interface that a SP may use to easily reach, inter alia, one or more external entities such as a credit card or debit card clearinghouse, a carrier billing system, a service bureau that provides access to multiple carrier billing systems, etc.

SP 114 AS 120. Facilities that provide key elements of the instant invention (which will be described below).

In the discussion below, reference is made to messages that are sent, for example, between a SU (e.g., Mary) 102 and an SP 114. As set forth below, a given “message” sent between Mary 102 and an SP 114 may actually comprise a series of steps in which the message is received, forwarded and routed between different entities, including Mary's WD 104, a WC 110, a MICV 112, and a SP 114. Thus, unless otherwise indicated, it will be understood that reference to a particular message, such as, for example, a response message, generally includes that particular message as conveyed at any stage between an origination source, such as Mary's WD 104, and an end receiver, such as an SP 114. As such, reference to a particular message generally includes a series of related communications between, for example, Mary 102 and a WC 110, the WC 110 and a MICV 112, and the MICV 112 and an SP 114. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

In FIG. 1 the exchanges that are collected under the designation Set 1 represent the activities that might take place as:

A) Mary 102 uses one of her PCs 106 to visit a SP's WS 116 to, possibly among other things, complete a service Registration process (122→124).

B) The SP's WS 116 interacts with the SP's AS 120 to, possibly among other things, commit the information that Mary 102 provided to a SP 114 data repository (e.g., a database), optionally complete a billing transaction, etc. (126).

C) The SP BI 118 optionally completes a billing transaction (128→130).

D) The SP's WS 116 responds appropriately (e.g., with the presentation of a confirmation message, etc.) (134→136).

The specific exchanges that were described above (as residing under the designation Set 1) are illustrative only and it will be readily apparent to one of ordinary skill in the relevant art that numerous other exchanges are easily possible and indeed are fully within the scope of the present invention.

The information that Mary 102 provided during the service Registration process may be preserved in a SP 114 data repository (e.g., a database) and may optionally be organized as a SU Profile. For purposes of illustration a hypothetical SU Profile might contain, inter alia:

A) SU Identifying Information. For example, possibly among other things, a unique identifier and a password, name, address, landline and wireless telephone numbers, e-mail addresses, instant messenger names/identifiers, etc.

B) Devices to be Monitored. For example, possibly among other things, the identifier (e.g., such as an Internet Protocol [IP] address, a device name, etc.), characteristics, etc. of each device (e.g., PC, etc.) that is to be monitored and for each device an indication of whether Local Monitoring or Remote Monitoring will be employed.

With Local Monitoring the monitored device may be examined directly (e.g., natively, through the addition of a software probe, etc.) and the occurrence of candidate activity may be conveyed to a SP for processing.

With Remote Monitoring the communication traffic from the monitored device may be examined (within, for example, an ISP) for the presence of candidate activity and the occurrence of candidate activity may be conveyed to a SP for processing.

C) Activities to be Monitored. For example, possibly among other things, the specific activities that are to be monitored (e.g., Web sites visited, chat rooms visited, programs run, etc.) and the associated constraints (e.g., keywords, patterns, rules, counter thresholds, time-of-day and/or day-of-week, etc.) that are to be applied during monitoring. A Blacklist and/or a Whitelist may optionally be defined for each activity.

D) Monitoring Matrix. For example, possibly among other things, the association of specific Devices to be Monitored and specific Activities to be Monitored, along with supporting definitional material such as scheduling constraints (e.g., time-of-day and/or day-of-week) and desired Level of Service.

Different Levels of Service may be offered by a SP. For example, possibly inter alia, simple monitoring and alerting, the automatic blocking of identified activity, the conditional blocking of identified activity, etc. Each level may carry with it a different pricing model.

E) SU Billing Information. Different service billing models may be offered including, inter alia, a fixed one-time charge, a recurring (monthly, etc.) fixed charge, a recurring (monthly, etc.) variable charge, etc. Different SU payment mechanisms may be supported including, possibly among other things, credit or debit card information, authorization to place a charge on a SU's phone bill, etc.

The specific pieces of profile information that were described above are illustrative only and it will be readily apparent to one of ordinary skill in the relevant art that numerous other pieces of information (e.g., scheduled daily/weekly/etc. reporting desired and/or on-demand reporting desired, etc.) are easily possible and indeed are fully within the scope of the present invention.

As noted above, the BI 118 may optionally complete a billing transaction. The billing transaction may take any number of forms and may involve different external entities (e.g., a WC's billing system, a carrier billing system service bureau, a credit or debit card clearinghouse, etc.). The billing transaction may include, inter alia:

1) The appearance of a line item charge on the bill or statement that a SU 102 receives from her WC 110. Exemplary mechanics and logistics associated with this approach are described in pending U.S. patent application Ser. No. 10/837,695 entitled “SYSTEM AND METHOD FOR BILLING AUGMENTATION.” Other ways of completing or performing line item billing are easily implemented by those skilled in the art.

2) The charging of a credit card or the debiting of a debit card.

In FIG. 1 the exchanges that are collected under the designation Set 2 represent the activities that might take place as the SP's AS 120 dispatches one or more confirmation e-mail messages (138→142) to the e-mail address that was provided by Mary 102.

The specific exchanges that were described above (as residing under the designation Set 2) are illustrative only and it will be readily apparent to one of ordinary skill in the relevant art that numerous other exchanges are easily possible and indeed are fully within the scope of the present invention.

In FIG. 1 the exchanges that are collected under the designation Set 3 represent the activities that might take place as the SP's AS 120 dispatches one or more confirmation SMS, MMS, etc. messages (144→148) to Mary's WD 104 and Mary 102 replies or responds (150→154) to the message(s). In the instant example the messages are shown traversing a MICV 112. The SP 114 may employ a Short Code (SC) or a regular Telephone Number (TN) as its source address (and to which it would ask users of its service to direct any reply messages). While the abbreviated length of a SC (e.g., five or six digits for a SC administered by Neustar under the Common Short Code [CSC] program) incrementally enhances the experience of a SU 102 (e.g., the SU need remember and enter only a few digits as the destination address of a reply message) it also, by definition, constrains the universe of available SCs thereby causing each individual SC to be a limited or scarce resource and raising a number of SC/CSC management, etc. issues. A description of a common (i.e., universal) short code environment may be found in pending U.S. patent application Ser. No. 10/742,764 entitled “UNIVERSAL SHORT CODE ADMINISTRATION FACILITY.”

The Web-based, e-mail, SMS/MMS, etc. confirmation message(s) that were described above may optionally contain an informational element—e.g., ‘Thank you for using our service!’, etc. The informational element may be selected statically (e.g., all generated messages are injected with the same informational text), randomly (e.g., a generated message is injected with informational text that is randomly selected from a pool of available informational text), or location-based (i.e., a generated message is injected with informational text that is selected from a pool of available informational text based on the current physical location of the recipient of the message as derived from, as one example, a Location-Based Service [LBS] facility).

The confirmation message(s) may optionally contain advertising—e.g., textual material if an SMS model is being utilized, or multimedia (images of brand logos, sound, video snippets, etc.) material if an MMS model is being utilized. The advertising material may be selected statically (e.g., all generated messages are injected with the same advertising material), randomly (e.g., a generated message is injected with advertising material that is randomly selected from a pool of available material), or location-based (i.e., a generated message is injected with advertising material that is selected from a pool of available material based on the current physical location of the recipient of the message as derived from, as one example, a LBS facility).

The confirmation message(s) may optionally contain promotional materials (e.g., still images, video clips, etc.).

The specific exchanges that were described above (as residing under the designation Set 3) are illustrative only and it will be readily apparent to one of ordinary skill in the relevant art that numerous other exchanges are easily possible and indeed are fully within the scope of the present invention.

The Set 1, Set 2, and Set 3 exchanges that were described above are illustrative only and it will be readily apparent to one of ordinary skill in the relevant art that numerous other exchanges are easily possible and indeed are fully within the scope of the present invention.

To continue the narrative, next consider FIG. 2. This figure illustrates various of the exchanges or interactions that are possible during the Monitoring and Alerting aspects of the present invention. The entities that are depicted in FIG. 2 are the same as were depicted in, and described for, FIG. 1.

In FIG. 2 the exchanges that are collected under the designation Set 1 represent some activity by a user of one of Mary's PCs 206—e.g., visiting a Web site, participating in discussions in an on-line forum, downloading a song or a movie through a file sharing facility, etc. (222→224).

The specific exchanges that were described above (as residing under the designation Set 1) are illustrative only and it will be readily apparent to one of ordinary skill in the relevant art that numerous other exchanges are easily possible and indeed are fully within the scope of the present invention.

In FIG. 2 the exchanges that are collected under the designation Set 2 represent the Monitoring activities that might take place as the SU PC 206 interacts with the SP AS 220 to confirm whether an identified activity does, in fact, match the various SU-supplied or SU-defined constraints (226→232).

A Local Monitoring approach is depicted. Under this approach the SU PC may be examined directly (e.g., natively, through the addition of a software probe, etc.) and the occurrence of candidate activity may be conveyed to the SP 214 for processing. Alternatively, Remote Monitoring may be employed. Under that approach the communication traffic from the SU PC 206 may be examined (within, for example, an ISP) for the presence of candidate activity and the occurrence of candidate activity may be conveyed to the SP 214 for processing.

The specific exchanges that were described above (as residing under the designation Set 2) are illustrative only and it will be readily apparent to one of ordinary skill in the relevant art that numerous other exchanges are easily possible and indeed are fully within the scope of the present invention.

In FIG. 2 the exchanges that are collected under the designation Set 3 represent various of the Alerting activities that might take place when an activity that was identified through Monitoring is confirmed to match the various SU-supplied or SU-defined constraints. For example, possibly among other things, the SP AS 220 may dispatch one or more (SMS, MMS, etc.) notification messages (234→238) to Mary's WD 204. In the instant example the messages are shown traversing a MICV 212. Additionally, the SP AS 220 may optionally dispatch one or more notification messages to Mary's e-mail address.

The notification message(s) that were described above may optionally contain an informational element—e.g., a description of the identified activity, etc. The informational element may be selected statically (e.g., all generated messages are injected with the same informational text), randomly (e.g., a generated message is injected with informational text that is randomly selected from a pool of available informational text), or location-based (i.e., a generated message is injected with informational text that is selected from a pool of available informational text based on the current physical location of the recipient of the message as derived from, as one example, a LBS facility).

The notification message(s) may optionally contain advertising—e.g., textual material if an SMS model is being utilized, or multimedia (images of brand logos, sound, video snippets, etc.) material if an MMS model is being utilized. The advertising material may be selected statically (e.g., all generated messages are injected with the same advertising material), randomly (e.g., a generated message is injected with advertising material that is randomly selected from a pool of available material), or location-based (i.e., a generated message is injected with advertising material that is selected from a pool of available material based on the current physical location of the recipient of the message as derived from, as one example, a LBS facility).

The notification message(s) may optionally contain promotional materials (e.g., still images, video clips, etc.).

If Mary 202 has previously arranged for the automatic blocking of the class of activity within which the identified activity resides then the identified activity will immediately be blocked—under a Local Monitoring approach at the SU PC 206; under a Remote Monitoring approach within, for example, a SU's ISP 208.

The specific exchanges that were described above (as residing under the designation Set 3) are illustrative only and it will be readily apparent to one of ordinary skill in the relevant art that numerous other exchanges are easily possible and indeed are fully within the scope of the present invention.

If Mary 202 has previously selected a ‘conditional blocking’ (or equivalent) level of service then the notification messages (234→238) may optionally contain a ‘Do you want to block this activity (Y/N)?’ inquiry. If Mary 202 responds or replies in the affirmative then the identified activity will immediately be blocked (as illustrated, for example, through the exchanges that are collected under the designation Set 4 in FIG. 2—e.g., 240→248).

The specific exchanges that were described above (as residing under the designation Set 4) are illustrative only and it will be readily apparent to one of ordinary skill in the relevant art that numerous other exchanges are easily possible and indeed are fully within the scope of the present invention.

The Set 1, Set 2, Set 3, and Set 4 exchanges that were described above are illustrative only and it will be readily apparent to one of ordinary skill in the relevant art that numerous other exchanges (e.g., optionally making the user of a SU PC 206 aware that their activity has been caught) are easily possible and indeed are fully within the scope of the present invention.

As activity is monitored, alerts are dispatched, and actions are taken a comprehensive history of same is optionally preserved within a repository (e.g., database) within a SP 214. Among other things, such a repository may be used to support scheduled (e.g., daily, weekly, etc.) and/or on-demand reporting with report results delivered (to, for example, a SU 202) through SMS, MMS, etc. messages; through e-mail; through a Web-based facility; etc.

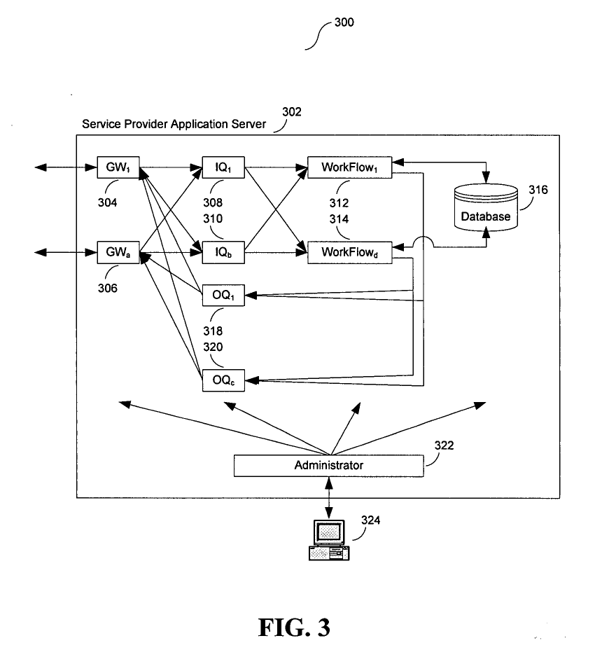

FIG. 3 provides a diagrammatic presentation of aspects of an exemplary SP AS 302. The illustrated AS 302 contains several key components—Gateways (GW₁ 304→GWₐ 306 in the diagram), Incoming Queues (IQ₁ 308→IQ_{b} 310 in the diagram), WorkFlows (WorkFlow₁ 312→WorkFlow_{d} 314 in the diagram), Database 316, Outgoing Queues (OQ₁ 318→OQ_{c} 310 in the diagram), and an Administrator 322. It will be readily apparent to one of ordinary skill in the relevant art that numerous other components are possible within an AS 302.

A dynamically updateable set of one or more Gateways (GW₁ 304→GWₐ 306 in the diagram) handle incoming (e.g., an occurrence of candidate activity) and outgoing (e.g., a notification message, a command to block activity, etc.) traffic. Incoming traffic is accepted and deposited on an intermediate or temporary Incoming Queue (IQ₁ 308→IQ_{b} 310 in the diagram) for subsequent processing. Processed artifacts are removed from an intermediate or temporary Outgoing Queue (OQ₁ 318→OQ_{c} 320 in the diagram) and then dispatched.

A dynamically updateable set of one or more Incoming Queues (IQ₁ 308→IQ_{b} 310 in the diagram) and a dynamically updateable set of one or more Outgoing Queues (OQ₁318→OQ_{c} 320 in the diagram) operate as intermediate or temporary buffers for incoming and outgoing traffic.

A dynamically updateable set of one or more WorkFlows (WorkFIow₁ 312→WorkFlow_{d} 314 in the diagram) remove incoming traffic from an intermediate or temporary Incoming Queue (IQ₁ 308→IQ_{b} 310 in the diagram), perform all of the required processing operations, and deposit processed artifacts on an intermediate or temporary Outgoing Queue (OQ₁ 318→OQ_{c} 320 in the diagram). The WorkFlow component will be described more fully below.

The Database 316 that is depicted in FIG. 3 is a logical representation of the possibly multiple physical repositories that may be implemented to support, inter alia, configuration, profile, monitoring, alerting, etc. information. The physical repositories may be implemented through any combination of conventional Relational Database Management Systems (RDBMSs) such as Oracle, through Object Database Management Systems (ODBMSs), through in-memory Database Management Systems (DBMSs), or through any other equivalent facilities.

An Administrator 322 provides management or administrative control over all of the different components of an AS through, as one example, a Web-based interface 324. It will be readily apparent to one of ordinary skill in the relevant art that numerous other interfaces (e.g., a data feed, etc.) are easily possible.

Through flexible, extensible, and dynamically updatable configuration information a WorkFlow (312→314) component may be quickly and easily realized to support any number of activities. For example, a WorkFlow might be configured to examine a received occurrence of candidate activity; retrieve the appropriate definitional material (e.g., elements of an SU Profile) from the Database 316; apply all of the indicated rules, patterns, thresholds, etc. from the SU Profile to the received occurrence of candidate activity to determine whether an instance of identified activity does, in fact, match the various SU-supplied or SU-defined constraints; complete all of the notification, alert, logging, etc. tasks that may be required; etc. The specific WorkFlow that was just described is exemplary only; it will be readily apparent to one of ordinary skill in the relevant art that numerous other WorkFlow arrangements, alternatives, etc. are easily possible.

Modular, flexible, easily extensible, and dynamically updateable configuration information (for an AS 302 as well as for each of the different components within an AS 304→322) may be housed in the configuration portion of the AS′ Database 316. The configuration information may be administered through the Administrator 322 (through which a comprehensive audit trail of access, changes, etc. may be maintained). The configuration information may be leveraged by the different components within an AS 302, including, for example, the Workflows 312→314 (to, for example, instruct a Workflow as to all manner of its operation including the number of internal threads that it should launch, the processing or throttling rates that it should employ, etc.)

Comprehensive Message Detail Records (MDRs) representing in-flight as well as completed (e.g., SU←→SP) message exchanges may be housed in the transaction portion of the AS′ Database 316.

The information that is maintained in an AS′ Database 316 may be used to support a range of real-time and/or off-line reporting capabilities. The information may be combined with other internal data (e.g., configuration information, etc.) and/or other external data (e.g., perhaps demographic, psychographic, etc. information from various third-party firms) to yield enhanced value-add reporting.

It is important to note that while aspects of the discussion that was presented above focused on the use of SCs, it will be readily apparent to one of ordinary skill in the relevant art that TNs and other message address identifiers are equally applicable and, indeed, are fully within the scope of the present invention.

The discussion that was just presented employed two specific wireless messaging paradigms—SMS and MMS. These paradigms potentially offer an incremental advantage over other paradigms in that native support for SM;S and/or MMS is commonly found on the mobile telephone that a potential SU would be carrying. However, it is to be understood that it would be readily apparent to one of ordinary skill in the relevant art that other paradigms are fully within the scope of the present invention.

It is important to note that the hypothetical example that was presented above, which was described in the narrative and which was illustrated in the accompanying figures, is exemplary only. It will be readily apparent to one of ordinary skill in the relevant art that numerous alternatives to the presented example are easily possible and, indeed, are fully within the scope of the present invention.

The following list defines acronyms as used in this disclosure.

| Acronym | Meaning |
|---|---|
| AS | Application Server |
| BI | Billing Interface |
| CSC | Common Short Code |
| DBMS | Database Management System |
| DSL | Digital Subscriber Line |
| GW | Gateway |
| IP | Internet Protocol |
| IQ | Incoming Queue |
| ISP | Internet Service Provider |
| LBS | Location-Based Service |
| MDR | Message Detail Record |
| MICV | Messaging Inter-Carrier Vendor |
| MMS | Multimedia Message Service |
| ODBMS | Object Database Management System |
| OQ | Outgoing Queue |
| PC | Personal Computer |
| RDBMS | Relational Database Management System |
| SC | Short Code |
| SMS | Short Message Service |
| SP | Service Provider |
| SU | Service User |
| TN | Telephone Number |
| WC | Wireless Carrier |
| WD | Wireless Device |
| WS | Web Server |
| WWW | World Wide Web |

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the relevant art in light of the above disclosure.

What is claimed is:

1. A method for monitoring Internet activity, comprising:
receiving at a Service Provider an indication of an occurrence of an event, said event having been previously defined by a Service User;
processing said indication and determining whether to raise an alert in view of a type of the event;
generating a notification message indicative of said type of event; and
dispatching said notification message to a Wireless Device of said Service User.

2. The method of claim 1, wherein said indication arises under a Local Monitoring process.

3. The method of claim 1, wherein said indication arises under a Remote Monitoring process.

4. The method of claim 1, wherein said event is defined by a Service User during a Registration process.

5. The method of claim 4, wherein said Registration process is Web-based.

6. The method of claim 4, wherein said Registration process includes a billing component.

7. The method of claim 4, wherein information gathered during said Registration process are preserved through a User Profile.

8. The method of claim 1, wherein said event encompasses a Personal Computer accessing a Web site.

9. The method of claim 1, wherein said event encompasses a Personal Computer participating in an on-line forum.

10. The method of claim 1, wherein said event encompasses a Personal Computer interacting with a file sharing facility.

11. The method of claim 1, wherein said event encompasses a Personal Computer interacting with a social networking facility.

12. The method of claim 1, wherein said notification message is an SMS messages.

13. The method of claim 1, wherein said notification messages is an MMS messages.

14. The method of claim 1, wherein said notification message contains advertising and/or promotional material.

15. The method of claim 1, further comprising:
conditionally automatically blocking said event.

16. The method of claim 15, wherein said blocking is accomplished consistent with a Local Monitoring process.

17. The method of claim 16, wherein said blocking is accomplished consistent with a Remote Monitoring process.

18. The method of claim 1, further comprising:
receiving a reply from said Service User;
processing said reply; and
conditionally blocking said event in response to said reply.

19. The method of claim 18, wherein said blocking is accomplished consistent with a Local Monitoring process.

20. The method of claim 18, wherein said blocking is accomplished consistent with a Remote Monitoring process.

21. A method of monitoring computer activity and providing an alert concerning said activity, the method comprising:
monitoring computer activity for a predetermined event;
upon detection of the predetermined event, confirming that the predetermined event matches a previously supplied constraint;
when the predetermined event matches the previously supplied constraint, sending a notification message to a wireless device indicative of the predetermined event; and
awaiting a response from the wireless device indicating whether to permit continued activity associated with the predetermined event.
